(19) United States
(12) Patent Application Publication
(10) Pub. No.: US 2006/0176143 A1
(43) Pub. Date: Aug. 10, 2006

(54) Potentiometer

(75) Inventor: Hans-Peter Ebnet, Oberhaching (DE)

Correspondence Address: SENNIGER POWERS, ONE METROPOLITAN SQUARE, 16TH FLOOR, ST LOUIS, MO, 63102, US

(73) Assignee: Bourns, Inc., Riverside, CA (US)

(21) Appl. No.: 11/342,434

(22) Filed: Jan. 30, 2006

(30) Foreign Application Priority Data
Feb. 7, 2005 (DE) 10 2005 005 752.7

(51) Int. Cl. H01C 10/00

(52) U.S. Cl. 338/68

(57) ABSTRACT

A potentiometer having a wiper track which is formed by a number of electrically conductive surfaces, a spacing between adjacent conductor surfaces, at least one contacts per wiper track fastened to a moving wiper, each contact is a cylindrical body whose length and arrangement are adapted to the width of the conductor surface and the width of the spacing so that in each position of the wiper at least one contact is in electrical contact with at least one conductor surface.

### FIELD OF THE INVENTION

The invention pertains to a potentiometer of the type having a wiper and a wiper track with spacing between conductive surfaces.

### BACKGROUND OF THE INVENTION

This type of potentiometer is known from DE 29 32 714 A1. This potentiometer, which is primarily used as a tank-filling level sensor in motor vehicles, has a wiper track consisting of a plurality of electrically conductive surfaces arranged mutually displaced and a wiper, movable along the wiper track, which has a contact that can move along the wiper track that makes contact with the individual conductor surfaces. The conductor surfaces are each connected to different locations of a resistance track so that pick-up is produced by adding partial resistances per contacted conductor surface. The wiper track is designed in the form of a curved path, over which the wiper is pivotable about an axis perpendicular to the plane of the wiper track and therefore to the conductor surfaces. During pivoting of the wiper about this axis, the contact slides along the wiper track.

An outward bulge in the form of a spherical cap of the wiper, a pinhead or other protrusion on the wiper has thus far been used as the contact, which, apart from deformations or abrasion, produces an essentially point-like contact with the conductor surfaces. Use of only one contact presents the problem that it makes no contact with one of the conductor surfaces in the transition region between two adjacent conductor surfaces of the wiper track or only poor contact with one of the conductor surfaces. Since the conductor surfaces normally protrude from a support substrate, the intermediate space between adjacent conductor surfaces is somewhat deeper so that the contact sinks into this intermediate space and then must be raised again to the conductor surface so that higher wear occurs on the edges of the conductor surfaces, resulting in a potentiometer with a shortened service life and that is susceptible to errors.

The problem of the invention is therefore to improve that potentiometer just mentioned so that it is less susceptible to errors, has a longer service life and always ensures perfect electrical contact between the contact and the conductor surfaces of the wiper track.

This problem is solved by the features of Claim 1. Advantageous embodiments and modifications of the invention are apparent in the dependent claims.

### SUMMARY OF THE INVENTION

The basic principle of the invention is that at least one, preferably two or even several, cylindrical contacts are to be applied to the wiper, whose length and arrangement is adapted to the width of the conductor surfaces and the width of the spacing so that, in each position of the wiper, at least one contact is in electrical contact with at least one conductor surface. Linear contact is therefore present between the contacts and the wiper track.

The arrangement of the contact or contacts at an acute angle relative to the longitudinal axis of the wiper is preferably made so that the contact has a widened contact region or overlapping region in the longitudinal direction of the wiper track, i.e., in the movement direction of the wiper. The angle lies between about 5 and 15° and is preferably 12°.

When two contacts per wiper track are used, they are mutually displaced. The separation is then provided in two directions, namely in the longitudinal direction of the wiper track and in the direction of a common longitudinal axis of the contacts.

The separation of two contacts in the longitudinal direction of the wiper track is greater than the distance between two adjacent conductor surfaces, but smaller than the sum of the distance between two adjacent connecters plus the width of one conductor surface. It is thereby ensured that at least one contact contacts at least one conductor at all times.

The contacts can have straight or obliquely running faces so that they run either at an angle to the edge of the spring arms to which they are fastened or parallel to them.

### BRIEF DESCRIPTION OF THE DRAWINGS

The invention is explained in greater detail below by means of embodiments in conjunction with the drawing. In the drawing:

FIG. 1 shows an enlarged cut-out of the contacting sites of the potentiometer according to one embodiment of the invention;

FIG. 2 shows a top view of a wiper with contacts according to another embodiment of the invention;

FIG. 3 shows a side view of the wiper of FIG. 2;

FIG. 4 shows an enlarged front view of the wiper of FIG. 2;

FIG. 5 shows a schematic top view of the wiper tracks and contacts in a variant of the arrangement of the contacts according to the invention;

FIG. 6 shows a view similar to FIG. 5 with a different variant for arrangement of the contacts;

FIG. 7 shows an enlarged cut-out of a top view of the wiper with contacts according to another variant of the invention;

FIG. 8 shows a top view similar to FIG. 7 with another variant for design of the contacts;

FIG. 9 shows a top view of a wiper similar to FIG. 1 according to a variant of the invention and

FIG. 10 shows an enlarged depiction of conductor surfaces of the wiper track and contact surfaces of the contacts.

### DETAILED DESCRIPTION OF THE INVENTION

This application claims priority of German application 10 2005 005 752.7, filed Feb. 7, 2005, the entire disclosure of which is hereby incorporated by reference.

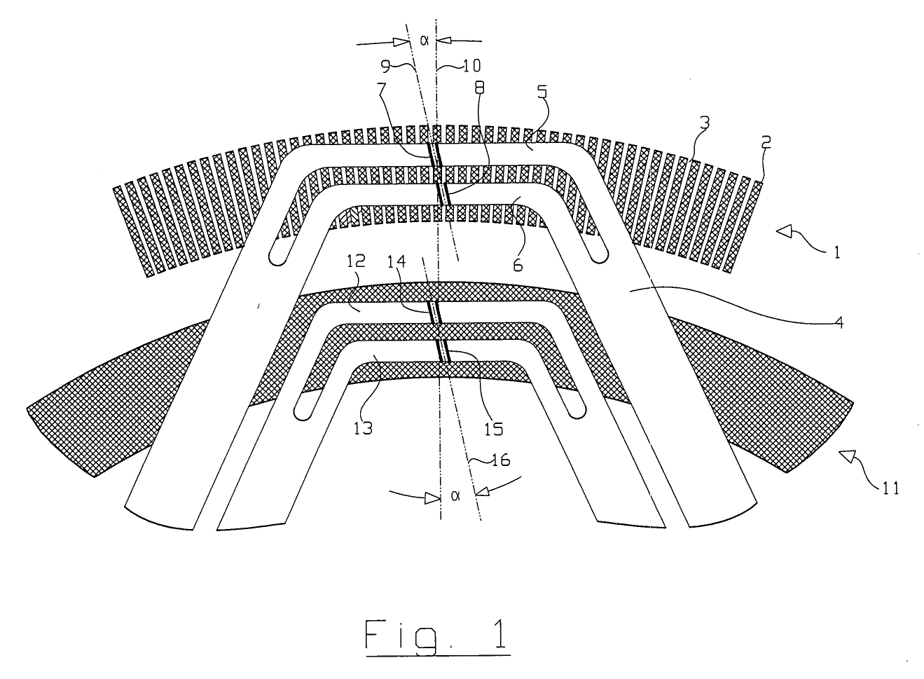

A wiper track 1 is shown in FIG. 1, which is formed from number of radially running conductor surfaces 2 made from an electrically conductive material, a gap 3 being present between adjacent conductor surfaces 2. The conductor surfaces 2 are ordinarily applied to a support material or substrate (not shown) and therefore protrude from it somewhat so that the gaps 3 form cutouts between the conductor surfaces 2. The wiper track 1 overall is designed in the form of a curved path, as is common in a rotary potentiometer. The individual conductor surfaces can be aligned with their longitudinal axis on the rotational center point of the rotary potentiometer (not shown). However, they can also lie parallel to each other. The individual conductor surfaces 2 are connected to a resistance track in known fashion (and therefore not shown here) so that a discrete resistance value can be picked up on each individual conductor surface.

For electrical pickup a wiper 4 is provided, which has two parallel spring arms 5 and 6 in the region covering the wiper track 1, on which contacts 7 and 8 are mounted. The contacts are cylindrical wires here, which are welded or soldered to the spring arms 5 and 6.

The two cylindrical contacts 7 and 8 are aligned along a common center axis 9, which forms an acute angle α relative to a center axis 10 of the wiper 4, which amounts to 12°, for example. The two contacts 7 and 8 are therefore arranged offset both with respect to the center axis 10 of the wiper and with respect to the wiper track 1, i.e., with respect to the direction of movement along wiper track 1. This offset in both directions, the length of the contacts 7 and 8, the width of the conductor surfaces 2 and the gaps 3 in the direction of movement along the wiper track 1 are adjusted to each other so that in each possible position of the wiper 4, at least one of the two contacts 7 or 8 contacts at least one of the conductor surfaces 2. Consequently, it cannot happen that both contacts 7 and 8 are fully in one of the gaps 3 so that no contact with one of the conductor surfaces 2 would be present.

Some potentiometers have an additional wiper track 11 used for power supply or as a center pickup, among other things. In the embodiment depicted here, the additional wiper track 11 is arranged concentric to the wiper track 1. The wiper 4, which has spring properties, has additional spring arms 12 and 13 to which contacts 14 and 15 are also fastened with the same design and arrangement as the contacts 7 and 8 already described. The characteristics of the second wiper track and its corresponding contacts on the wiper are the same as for the other wiper track. That is, the second wiper track has electrically second conductive surfaces, each having a second conductor surface width, and a second conductor spacing having a second conductor spacing width present between adjacent conductor surfaces. The wiper in these instances therefore has at least one second contact having a second contact length and second contact arrangement on the wiper and comprising a second cylindrical body fastened to the wiper. The second contact length, said second contact arrangement, said second conductor spacing, said second conductor surface width, and said second conductor spacing width are selected relative to each other so that in each position of the wiper, at least one second contact makes electrical contact with at least one second conductor surface.

In the embodiment depicted here, the pairs of contacts 7, 8 and 14, 15 are aligned relative to the center axis 10 of the wiper 4 so that the common center axis 9 of the contacts 7 and 8 and a common center axis 16 of the contacts 14 and 15 lie parallel and mutually displaced.

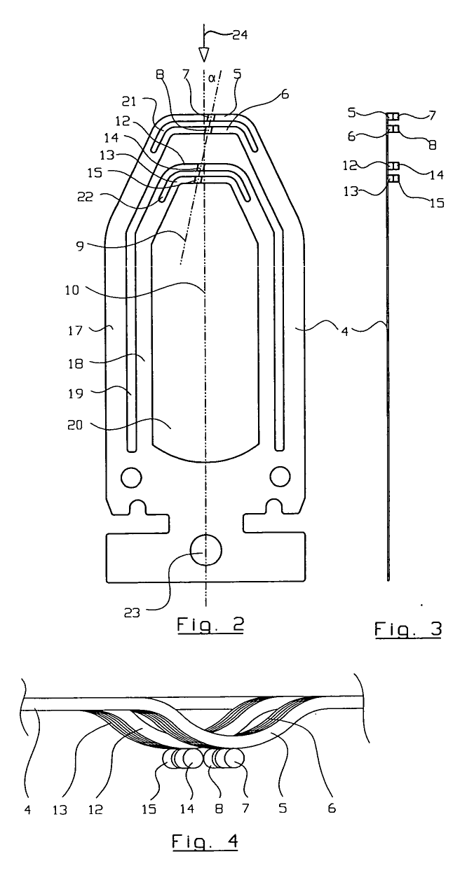

FIG. 2 shows a top view of a complete wiper 4, which can be produced as a punched part from their metal sheet. It has two bracket-like or roughly U-shaped spring arms 17 and 18, which are separated by cutout 19 from each other in which the inner spring arm 18 has a relatively large cutout 20. The two spring arms 17 and 18 are connected to each other on the remaining part of the wiper 4. Both spring arms 17 and 18 in their center part have cutouts 21 and 22 to form the spring arms 5, 6 and 12, 13, contacts 7, 8 and 14, 15 being mounted on the latter.

Except for the contacts 7, 8, 14, and 15, the wiper 4 is designed nearly symmetric around its longitudinal axis 10. A circular opening 23, by means of which the wiper 4 is fastened to a rotating shaft, is present on the end of the wiper opposite the contacts.

FIG. 3 shows a side view of the wiper in FIG. 2. It is apparent that the wiper 4 is produced from a thin metal sheet. It is also apparent that the spring arms 5, 6, 12 and 13 have protruding bends or bulges from the plane of the wiper 4 in the region of the contacts 7, 8, 14 and 15, to which the contacts 7, 8, 14 and 15 are fastened.

This is even more apparent in FIG. 4, which shows a strongly enlarged cutaway front view of the wiper of FIG. 2 viewed in the direction of arrow 24. It is readily apparent from FIG. 4 that the spring arms 5, 6 and 12, 13 are bent in the direction toward the contacts 7, 8, 14 and 15, in which these bends are designed according to the offset of the contacts mentioned in conjunction with FIG. 1, so that each of the corresponding contacts 7, 8, 14 and 15 always lie precisely in the center of the corresponding bend in order to create identical spring properties for each of the contacts.

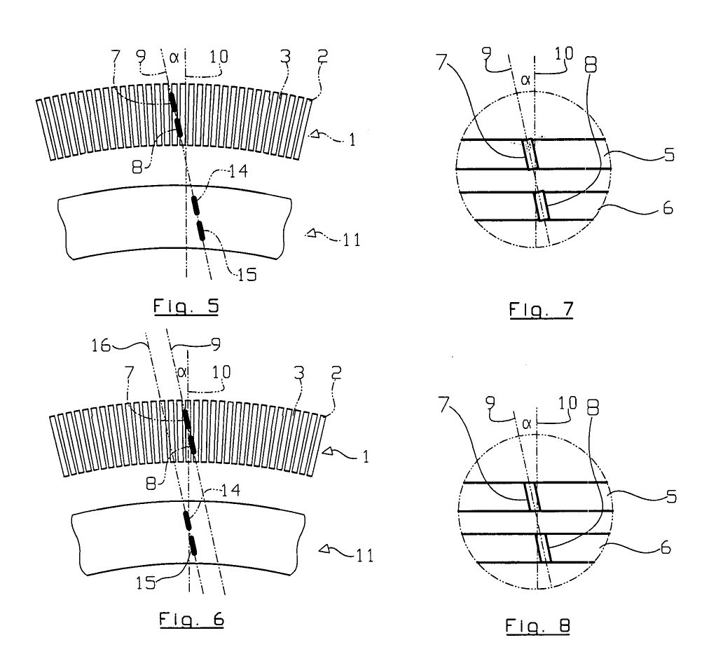

FIGS. 5 and 6 show two variants of the arrangement of the contacts. In the variant of FIG. 5, all contacts 7, 8, 14 and 15 are aligned along a single common axis 9, which is at an angle α to the longitudinal axis 10 of wiper 4, where the axis 9 intersects longitudinal axis 10 roughly in the center between the two wiper tracks 1 and 11.

In the variant of FIG. 6, the contacts 7 and 8 are aligned along a first axis 9 and the contacts 14 and 15 along the second axis 16, the two axes 9 and 16 being mutually displaced, and intersecting longitudinal axis 10 of wiper 4 roughly in the center of wiper tracks 1 and 11.

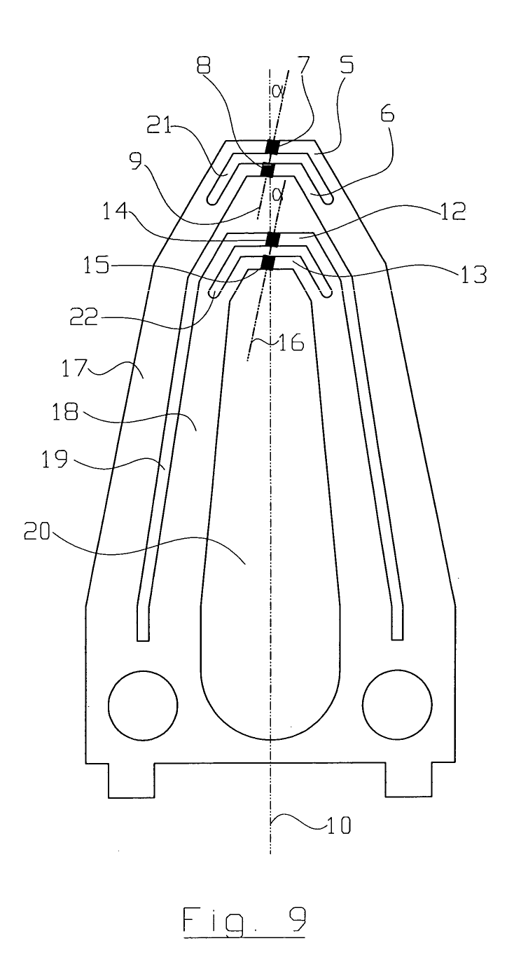

FIGS. 7 and 8 show an enlarged top view of the contacts 7 and 8. In the variant of FIG. 7, the cylindrical contacts 7 and 8 are separated perpendicular to their longitudinal axis 9 and form with the front sides an acute angle relative to the edges of the spring arms 5 and 6, in which they protrude by half of their diameter beyond the edges in the embodiment of FIG. 7. The front edges of their contacts (i.e., the edges which protrude partly beyond the edges of the spring arms) run at right angles to the longitudinal axis of the contacts.

In the variant of FIG. 8, the cylindrical contacts 7 and 8, on the other hand, are flush with the edges of spring arms 5 and 6. The front edges of the contacts therefore form an acute angle (90°−α) measured clockwise from these edges to the longitudinal axis 9. Stated another way, the contacts have front edges running at an obtuse angle (90+α) measured clockwise from the longitudinal axis of the contacts to said front edges.

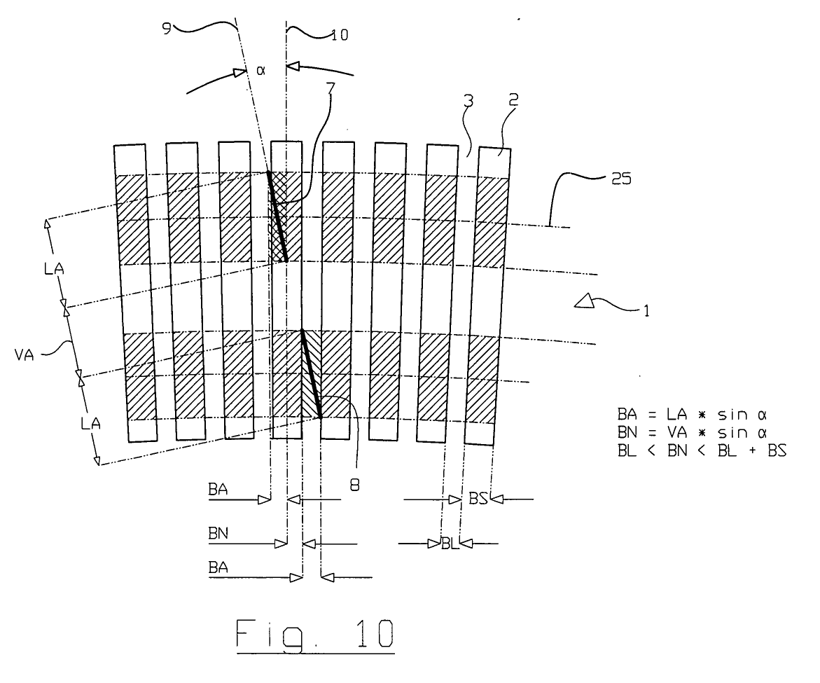

FIG. 9 shows a top view of a wiper similar to FIG. 2, but with an arrangement of the contacts 7, 8, 14 and 15 according to the embodiments of FIGS. 6 and 7, where it is pointed out that the variants of FIGS. 5 and 6 can be arbitrarily combined with those in FIGS. 7 and 8.

In comparison to FIG. 2, FIG. 9 also shows that the spring arm can be arbitrarily configured.

FIG. 10 shows an enlarged section of part of the wiper track 1 and two contacts 7 and 8, which are shown only as a line to indicate line contact with the conductor surfaces 2 of the wiper track 1. Each of the two contacts 7 and 8 has a length LA and is aligned along axis 9, which forms an acute angle α relative to longitudinal axis 10 and conductor surfaces 2 (and the not-shown wiper 4). In the longitudinal direction 25 of the wiper track 1, the conductor surfaces 2 have a width BS and the gaps 3 have a width BL. The contacts 7 and 8 therefore have a covering width BA, which is obtained as
BA=LA·sin α.

The regions of the conductor surfaces 2 that can come in contact with the contact 7 or 8 are shown in right hatching in FIG. 10. The contact region covered by the contact 7 or 8 is shown in left hatching. In the position of the contacts of FIG. 10, the contact 8 falls precisely in a gap 3 between two adjacent conductor surfaces 2 and therefore has no contact with the wiper track. The contact 7, on the other hand, has contact with a conductor surface 2 with the greater part of its covering region BA, namely in the cross-hatched region.

When only one contact is used on wiper track 1, contact is always reliably obtained if the width BL of the gaps 3 is smaller than the width BA of the covering of a contact, i.e., if
BL<LA·sin α.

This condition must be rigorously complied with in terms of manufacture based on the accuracy of angle α, under which the cylindrical contacts are soldered to the wiper 4, wherein, because of the small unevenness of conductor surface 2 or the outside surface of the cylindrical contact, an exact linear contact over the entire length of the contacts does not always occur, but sometimes only point-like contacts.

For this reason it is preferred to use two contacts per wiper track, which are separated in the longitudinal direction of the contacts. Double contact is therefore obtained, which is much less susceptible to errors. The separation in the longitudinal direction of the two contacts 7 and 8, i.e., in the direction of the common axis 9, is denoted VA. The width BN of the separation of the contacts 7 and 8 in directions 25 of the wiper track 1, i.e., the region that is not covered by the contacts, therefore amounts to
BN=VA·sin α.

In order for at least one contact 7 and/or 8 to always be in contact with conductor surface 2 and for two contacts 7 and 8 not to lie in gap 3 between two conductor surfaces 2, the following conditions must be met:

The separation BN in the longitudinal direction 25 of the wiper track must be greater than the gap BL between two adjacent conductor surfaces 2, and the separation BN must be smaller than BL plus BS.

When these two conditions are met, the angle α is not critical and can even be zero in the extreme case if it is also preferred to have a non-zero angle α, which is chosen together with the length LA of the contact so that a contact touches a maximum of two adjacent conductor surfaces. The angle α preferably lies in the range 10±5° and is preferably about 12°.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. A potentiometer comprising:
a wiper track having electrically conductive surfaces, each having a conductor surface width, and a spacing having a spacing width is present between adjacent conductor surfaces; and
a wiper having at least one contact having a length and arrangement on the wiper and comprising a cylindrical body fastened to the wiper;
wherein said length, said arrangement, said spacing, said conductor surface width, and said spacing width are selected relative to each other so that in each position of the wiper, at least one contact makes electrical contact with at least one conductor surface.

2. The potentiometer according to claim 1 wherein said at least one contact is arranged at an acute angle relative to a longitudinal axis of the wiper.

3. The potentiometer according to claim 2 wherein said angle lies between 5 and 15°.

4. The potentiometer according to claim 2 wherein said angle is about 12°.

5. The potentiometer according to claim 1 wherein said at least one contact comprises at least two contacts which are mutually displaced in the direction of the wiper track.

6. The potentiometer according to claim 3 wherein said at least one contact comprises at least two contacts which are mutually displaced in the direction of the wiper track.

7. The potentiometer according to claim 4 wherein said at least one contact comprises at least two contacts which are mutually displaced in the direction of the wiper track.

8. The potentiometer according to claim 5 wherein said at least two contacts are arranged along a common axis and at a spacing relative to each other.

9. The potentiometer according to claim 8 wherein an offset of the two contacts in a longitudinal direction of the wiper track is greater than said spacing of adjacent conductor surfaces but is less than the sum of the distance between adjacent conductor surfaces and the width of one conductor surface.

10. Potentiometer according to claim 8 wherein the contacts are applied to parallel spring arms of the wiper.

11. The potentiometer of claim 10 wherein the contacts are welded or soldered to the spring arms.

12. The potentiometer according to claim 10 wherein the contacts have front edges running at right angles to a longitudinal axis of the contacts.

13. The potentiometer according to claim 10 wherein the contacts have front edges running at an obtuse angle measured clockwise from a longitudinal axis of the contacts to said front edges.

14. The potentiometer according to claim 10 wherein the contacts have front edges running at a right angle to a longitudinal axis of the wiper.

15. The potentiometer according to claim 1 wherein the potentiometer further comprises:
a second wiper track having electrically second conductive surfaces, each having a second conductor surface width, and a second conductor spacing having a second conductor spacing width present between adjacent conductor surfaces; and
said wiper has at least one second contact having a second contact length and second contact arrangement on the wiper and comprising a second cylindrical body fastened to the wiper;
wherein said second contact length, said second contact arrangement, said second conductor spacing, said second conductor surface width, and said second conductor spacing width are selected relative to each other so that in each position of the wiper, at least one second contact makes electrical contact with at least one second conductor surface.

16. The potentiometer according to claim 15 wherein two contacts are provided for each wiper track.

17. The potentiometer according to claim 16 wherein all contacts are aligned along a common axis which is arranged at an acute angle measured clockwise from said common axis to the longitudinal axis of the wiper.

18. The potentiometer according to claim 15 characterized by the fact that the contacts are arranged along two axes mutually displaced and parallel.

19. The potentiometer according to claim 1 wherein said at least one second contact is arranged at an acute angle relative to said longitudinal axis of the wiper.

20. The potentiometer according to claim 19 wherein said angle between the second contact and said longitudinal axis lies between 5 and 15°.

21. The potentiometer according to claim 15 wherein said at least one second contact comprises at least two second contacts which are mutually displaced in the direction of the wiper track.
